(19) United States
(12) Patent Application Publication
(10) Pub. No.: US 2009/0228945 A1
(43) Pub. Date: Sep. 10, 2009

(54) SYSTEMS, METHODS, AND COMPUTER PRODUCTS FOR INTERNET PROTOCOL TELEVISION MEDIA CONNECT

(75) Inventor: Buddy Yaussy, Duluth, GA (US)

Correspondence Address: AT&T Legal Department - CC;Attn: Patent Docketing, Room 2A-207, One AT&T Way, Bedminster, NJ, 07921, US

(73) Assignee: AT&T Delaware Intellectual Property, Inc., Wilmington, DE (US)

(21) Appl. No.: 12/042,002

(22) Filed: Mar. 4, 2008

(51) Int. Cl. H04N 7/173

(52) U.S. Cl. 725/110; 725/109

(57) ABSTRACT

Systems, methods and computer program products for Internet Protocol Television media connect are provided. Exemplary embodiments include a content management method, including searching for locations of local audio/video assets available on a local area network, aggregating the locations of the local audio/video assets on a device on the local area network and presenting the local audio/video assets on a communications device coupled to the local area network.

### BACKGROUND

Exemplary embodiments relate generally to communications systems, and more particularly, to systems, methods and computer program products for Internet Protocol Television media connect.

Internet protocol television (IPTV) is a digital television delivery service wherein the digital television signal is delivered to residential users via a computer network infrastructure using the Internet Protocol. Typically, IPTV services are bundled with additional Internet services such as Internet web access and voice over Internet protocol (VOIP). Subscribers receive IPTV services via a set-top box that is connected to a television or display device for the reception of a digital signal. Used in conjunction with an IP-based platform, the set-top box allows for a subscriber to access IPTV services and any additional services that are integrated within the IPTV service. In addition, DVRs can be coupled to the IPTV-enabled devices in order to record the content available from IPTV.

IPTV service platforms allow for an increase in the interactive services that can be provided to residential subscriber. As such, a subscriber can have access to a wide variety of content that is available via the IPTV service or the Internet. For example, a subscriber may utilize interactive services via a set top box to view IPTV content or access their personal electronic messaging accounts via an Internet web browser. The IPTV infrastructure also allows the delivery of a variety of video content instantly to the subscribers. Such content can be recorded on the subscriber's DVR.

Currently, IPTV set top boxes can include a client that can connect to other devices on a local area network (LAN) in communication with a local IPTV set top box. As such, the local IPTV set top box can make audio and video assets on devices in communication with the LAN available to the set top box and thus an IPTV enabled television coupled to the set top box. The subscriber can therefore play the audio and video assets through the IPTV enabled TV via the client. However, the current above-described clients are unable to communicate with and play audio and video assets beyond the LAN.

### BRIEF SUMMARY

Exemplary embodiments include a content management method, including searching for locations of local audio/video assets available on a local area network, aggregating the locations of the local audio/video assets on a device on the local area network and presenting the local audio/video assets on a communications device coupled to the local area network.

Additional exemplary embodiments include a computer program product for content management, the computer program product including instructions for causing a computer to implement a method, the method including searching for locations of local audio/video assets available on a local area network, aggregating the locations of the local audio/video assets on a device on the local area network and presenting the local audio/video assets on a communications device coupled to the local area network.

Further exemplary embodiments include a content management method, including searching for locations of local audio/video assets available on a local area network, and for locations of external audio/video assets available outside of the local area network, aggregating the locations of the local audio/video assets, and the locations of the external audio/video assets on a computing device coupled to the local area network, presenting the local audio/video assets and the external audio/video assets on a communications device coupled to a set top box configured to consume the local audio/video assets and the external audio/video assets and in response to a request to download a subset of the local audio/video assets and the external audio/video assets, retrieving the subset of the local audio/video assets and the external audio/video assets for presentation on the communications device.

Additional exemplary embodiments include a computer program product for content management, the computer program product including instructions for causing a computer to implement a method, the method including searching for locations of local audio/video assets available on a local area network, and for locations of external audio/video assets available outside of the local area network, aggregating the locations of the local audio/video assets, and the locations of the external audio/video assets on a computing device coupled to the local area network, presenting the local audio/video assets and the external audio/video assets on a communications device coupled to a set top box configured to consume the local audio/video assets and the external audio/video assets and in response to a request to download a subset of the local audio/video assets and the external audio/video assets, retrieving the subset of the local audio/video assets and the external audio/video assets for presentation on the communications device.

Further exemplary embodiments include a content management system, including a computing device, a set top box in communication with the computing device, a communications device in communication with the set top box, a process for presenting audio/video assets on the communications device, the process having instructions for searching for locations of local audio/video assets available on a local area network, and for locations of external audio/video assets available outside of the local area network, aggregating the locations of the local audio/video assets, and the locations of the external audio/video assets on a computing device coupled to the local area network, presenting the local audio/video assets and the external audio/video assets on a communications device coupled to a set top box configured to consume the local audio/video assets and the external audio/video assets and in response to a request to download a subset of the local audio/video assets and the external audio/video assets, retrieving the subset of the local audio/video assets and the external audio/video assets for presentation on the communications device.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates a block diagram of an exemplary Internet Protocol Television media connect services system; and

FIG. 2 illustrates a flow chart for a media connect service method in accordance with exemplary embodiments.

The detailed description explains the exemplary embodiments, together with advantages and features, by way of example with reference to the drawings.

### DETAILED DESCRIPTION OF EXEMPLARY EMBODIMENTS

Exemplary embodiments include systems and methods and computer program products for Internet Protocol Television media connect services, which provide organization and aggregation of multi-media content from a multiplicity of sources in both a local area network, and from media sources external to the local area network. In exemplary embodiments, the systems and methods described herein aggregate, organize and present multi-media material (assets) available to a central device in a subscriber location. In exemplary embodiments, the local assets can be from a variety of multi-media devices on a local area network in the subscriber location having content in a variety of formats. The content can be aggregated into a single device and presented to the subscriber in a format that is meaningful to the subscriber. For example, the content can be aggregated in a computing device, such as a set top box, connected to an IPTV enabled communications device having a user interface onto which the content is presented.

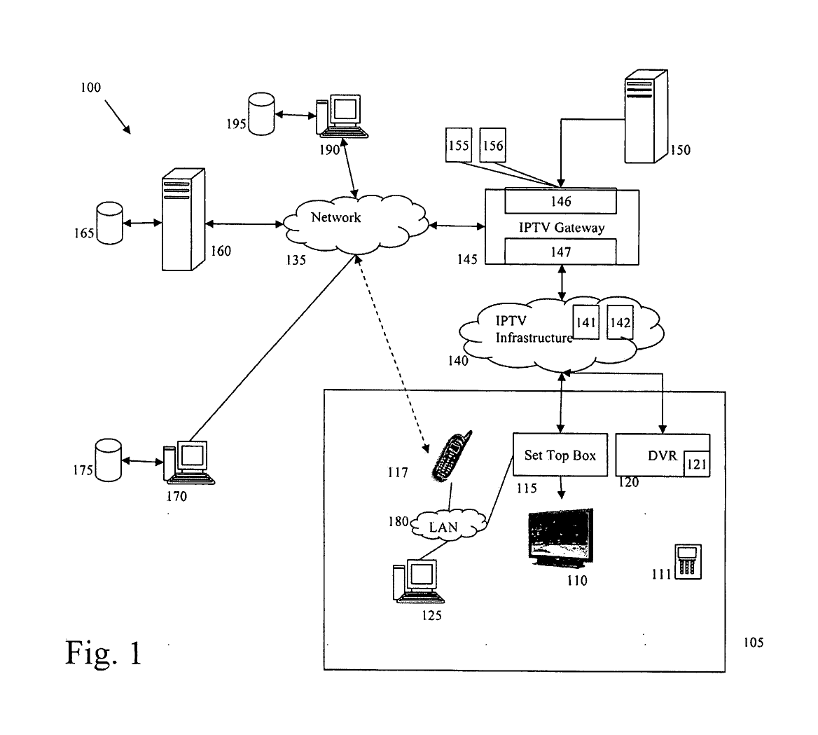

Turning now to FIG. 1, a block diagram of an exemplary Internet Protocol Television media connect services system 100 is now described. For ease of illustration, the system 100 of FIG. 1 depicts a simplified network infrastructure. In addition, for ease of illustration, the system 100 is described implementing an Internet Protocol Television (IPTV) system for reception of programming and scheduling. It is understood that the systems and methods described herein can implement television and program-viewing systems other than IPTV. For example, the system 100 can implement cable, satellite and antenna.

Furthermore, it is understood that a variety of network components/nodes may be utilized in implementing the embodiment described herein. For example, in exemplary embodiments, the system 100 includes a means for accessing network services for multiple disparate devices using a single sign on procedure. Therefore, the system 100 manages accounts, each of which is established for a community of devices and/or device subscribers, such as those devices and subscribers in a subscriber location 105, which may include a communications device 110 (e.g., an IPTV-enabled television) coupled to a computing device 115, such as a set top box. Where the communications device 110 is IPTV, the set top box 115 includes a processor that provides bidirectional communications between an IPTV infrastructure 140 and the communications device 110 and decodes the video streaming media received as content programming and onscreen programming information, from a content services provider server 160, discussed further below. Other services can be provided to the subscriber location, such as, but not limited to phone services, network services and other exemplary services such as media connect services that can be implemented via the communications device 110. The accounts may thus include phone, network access and IPTV services and may be used to provide access to the media connect services as described further herein. Furthermore, in exemplary embodiments, one of the devices (e.g., the communications device 110) can be provisioned for the network services described herein by associating a device identifier of the communications device with a respective account. The account, in turn, identifies each of the communications devices belonging to the community and provides other information as described herein. Furthermore, it is appreciated that other devices such as a subscriber computer 125 can be further included in the community of devices established for the subscriber location 105. It is appreciated that the subscriber computer 125 can be local to the subscriber location 105 or can represent any other remote computer that can be used to access the services described herein. It is further appreciated that other remote devices can be implemented to access the services described herein such as but not limited to a cellular telephone (e.g., a 3G cell phone), a personal computer, a laptop computer, a portable computing device (e.g., personal digital assistant), a console video game, and a digital music player (e.g., MP3 player), collectively represented as a device 117. As discussed further herein, a media connect services interface can be rendered on any of the above-referenced devices to implement the media connect services in accordance with exemplary embodiments. It is appreciated that the device 117 can include audio and video assets that can be made available to a single device in the subscriber location 105 via the media connect services as described further herein.

In exemplary embodiments, one of the devices, such as the communications device 110 (and the set top box 115, in combination) can be used to establish account services, such as the media connect services described herein. An account record may be generated for the subscriber at the subscriber location 105, which identifies the subscriber and the account for which the services (e.g., basic account services as described above and the media connect services described herein) are provided. Account information and records may be stored in a storage device accessible by an IPTV gateway 145, discussed below. In exemplary embodiments, the IPTV gateway 145 implements one or more applications for establishing and utilizing the media connect services account. Access to the media connect services account may thus be created for a community of communications devices (e.g., the communications device 110) to enable the communications devices to implement the media connect services as described herein. A preferences server 150, which is coupled to the IPTV gateway 145, includes preferences information for the subscriber location 105 as described further herein.

As discussed above, the system 100 of FIG. 1 includes the subscriber location 105, such as the subscriber's household. The subscriber location 105 can include the communications device 110 (e.g., an IPTV-enabled television) in communication with the set top box 115. The subscriber location 105 can further include a personal digital recorder such as a DVR. 120, which is in communication with the communication device 110 and the set top box 115. It is understood that the set top box 115 and the DVR 120 may be two separate devices or be a single integrated device. In exemplary embodiments, the DVR 120 is hard-disk based, but may have other suitable storage media such as a cache 121. It is appreciated that the DVR 120 can have other suitable memory devices for receiving and storing programming and scheduling data. Therefore, a “memory” or “recording medium” can be any means that contains, stores, communicates, propagates, or transports the program and/or data for use by or in conjunction with an instruction execution system, apparatus or device. The memory and the recording medium can be, but are not limited to, an electronic, magnetic, optical, electromagnetic, infrared or semiconductor system, apparatus or device. The memory and recording, medium also include, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored. It is appreciated that the DVR 120 may be local on the set top box 115 (as described), or networked, or on an allocated media server storage space.

The subscriber location 105 can further include a remote control 111 for control and navigation of the communications device 110. As further described herein the remote control 111 can be implemented to navigate the media connect services interface. As discussed above, the subscriber location 105 can further include one or more remote devices in its community of devices that can be made available to the subscriber location via the media connect services described herein. For example, the remote devices can include one or more external servers such as an RSS server 170 having audio and/or video assets in a storage medium 175. As further described herein, the audio/video assets from the storage medium 175, which are external to the subscriber location 105, can be made available to a local area network 180 in the subscriber location 105. As further described herein, application software residing on the subscriber computer 125 can be implemented to retrieve the external audio/video assets from the storage medium 175. It is understood by those skilled in the art that the remote subscriber computer 125 can include input and output devices, such as but not limited to a display, a mouse and a keyboard. Other devices that can access the media connect services include the device 117.

The system 100 can implement the media connect services such that desired IPTV media connect control, management and scheduling can be managed and viewed through the subscriber's IPTV-enabled device, such as the communications device 110, via the set top box 115, the remote devices (e.g., the subscriber computer 125, and the device 117) or other suitable device. As such, to coordinate IPTV communication, the system 100 may further include the IPTV gateway 145 that is in communication with the IPTV infrastructure 140. The IPTV infrastructure 140 and the IPTV gateway 145 are used in conjunction to communicate via a network 135. For example, a suitable device (e.g., the communications device 110, the device 117, and the subscriber computer 125) at the subscriber location 105 can implement the IPTV infrastructure 140 and the IPTV gateway 145 to communicate with the content services provider server 160 to access data from databases such as a database 165 (described further herein) for IPTV services available via the set top box 115.

In exemplary embodiments, as discussed above, the system 100 further includes the content services provider server 160, which is in communication with the IPTV gateway 145 via the network 135. In exemplary embodiments, the content services provider server 160 is implemented by a host system (e.g., a high-speed processing device) that provides content to its subscribers (e.g., a subscriber of the communications device 110), such as television programs, premium programming services, video on demand content, and Internet/Web content (e.g., podcasts, and streaming media). In exemplary embodiments, the content is transmitted to the subscribers (e.g., at the subscriber location 105) via a broadband connection over an Internet Protocol (IP)-based network (e.g., the network 135). The content services provider server 160 can also provide an onscreen programming guide (e.g., EPG) to customers (e.g., the subscriber) that provides information about current and future programming available via the content providers' services. Programming information provided by the onscreen programming guide may include current and future program listings including program titles, primary actors/actresses, begin time, duration of program, a year in which the program was produced, and a brief text description of the program.

In exemplary embodiments, the content services provider server 160 is coupled to the database 165. In one implementation, the database 165 may be representative of a given play list. A play list is associated with a particular program screen. For example, a play list can be generated for a given screen that is displayed for a view on the communications device 110. As a subscriber is browsing through different channels, and therefore different program content, as each new channel and program content are displayed on the communications device 110, a different play list is accessed by the communications device 110 from the content services provider server 160, which can be via set top box 115. In exemplary embodiments, play lists can include programming content, as well as programming schedules for the content (e.g., onscreen programming guide information (EPG)). In exemplary embodiments, the database 165 stores records of programming events scheduled for transmission to customers via, for example, the communications device 110. These records, in turn, can be used in conjunction with the DVR 120 in order to schedule recordings.

In exemplary embodiments, upon a request from the subscriber location 105, the IPTV gateway 145 can coordinate obtaining the acquired data from the database 165 and provide the acquired data for display and rendering at the subscriber location 105. According to exemplary embodiments, the coordination of acquiring the data and ultimately displaying the data on the communications device 110 (or other device) is implemented via a media connect services application 155.

In exemplary embodiments, upon a request from the subscriber location 105, the IPTV gateway 145 can coordinate obtaining the video from the database 165 and provide the acquired data (e.g., playlists and selected videos) for display and rendering at the subscriber location 105. As described, the coordination of acquiring the data and ultimately displaying the data on the communications device 110 (or other device) is implemented via the media connect services application 155. Furthermore, according to exemplary embodiments, the media connect services application 155 coordinates the transfer of the program data from the database 165 for rendering on the communications device 110.

The network 135 can be an IP-based network for communication between the content services provider server 160 and the subscriber location 105 using communication devices such as but not limited to the communications device 110 (via the set top box 115, for example). The network 135 can be implemented to transmit content from the content services provider server 160 to the subscriber location 105 via a broadband connection, for example. In exemplary embodiments, the network 135 can be a managed IP network administered by a service provider. The network 135 can also be implemented in a wireless fashion, e.g., using wireless protocols and technologies, such as Wi-Fi, Wi-Max, etc. The network 135 can also be a cellular communications network, a fixed wireless network, a wireless local area network (LAN), a wireless wide area network (WAN), a personal area network (PAN), intranet, metropolitan area network, Internet network, or other similar type of network environment or other suitable network system and includes equipment for receiving and transmitting signals. In other exemplary embodiments, the network 135 can be a circuit-switched network such as a standard public switched telephone network (PSTN).

In exemplary embodiments, the IPTV infrastructure 140 can be an IP-based network that receives network data (e.g., programming content for recording on the DVR 120) from the content services provider server 160 and the preferences server 150, and delivers the network data to the set top box 115 for display or other rendering on the communications device 110. Alternatively, the network data can be for display or rendering on the subscriber computer 125 or other suitable device, such as device 117.

In exemplary embodiments, as discussed above, the IPTV infrastructure 140 provides an interface between the subscriber location 105 and the IPTV gateway 145. In exemplary implementations, a notification server 141 and a terminal server 142 operate to interface communication between the subscriber location 105 via the set top box 115, and the IPTV gateway 145. For example, in exemplary implementations, the set top box 115 can provide a unique identification number so that the IPTV gateway 145 can route the network data to the set top box 115. In doing so, a message is passed between the notification server 141 and the set top box 115. Furthermore, the IPTV gateway 145 provides an interface between the content services provider server 160, and the IPTV infrastructure 140 and subscriber location 105.

In exemplary embodiments, the IPTV gateway 145 handles notifications to the IPTV subscriber location 105 and can further provide a history of the notifications. The media connect services application 155 can reside partially or wholly on the IPTV gateway to handle the notifications as further described herein. In exemplary embodiments, the media connect services application 155 can further reside partially or wholly on the set top box 115. In exemplary embodiments, the media connect services application 155 can further reside partially or wholly on the subscriber computer 125 as part of the client software for managing audio/video assets for the LAN 180. When the subscriber sets up his/her media connect services on the communications device 110 (or other device in the subscriber location 105 or remote device, such as the subscriber computer 125 and device 117), one of the network components of the system 100 (e.g., the set top box 115, or the IPTV gateway 145) can store specific scheduling information that the subscriber has created. For example, as discussed farther herein, each subscriber can access and manipulate viewing and recording information for the DVR 120 via an interface. As such, if the interface is stored on the IPTV gateway 145, messages and notifications can be passed between the subscriber location 105 and the IPTV gateway 145 that include present scheduling and historic scheduling that the subscriber has created in the past. Furthermore, if any changes in the subscriber's scheduled recordings have occurred, messages can be passed to the subscriber location 105 (or remote device) to notify the subscriber that a program scheduled to be recorded on the DVR 120 has changed. The subscriber can make changes accordingly.

In exemplary embodiments, the IPTV gateway 145 can further interface with the various system 100 elements as described herein. For example, the IPTV gateway 145 is in communication with the preferences server 150 to pass notifications and messages (e.g., Email messages) regarding permissions to create and edit media connect information. For example, different members of the subscriber location 105 who share account services may have different recording schedules. For example, one member may have a first unique recording schedule and another member may have a second unique recording schedule with little to no overlap with the first recording schedule. As such, each member can retrieve and edit those different schedules and be properly authenticated to retrieve and edit those schedules.

In exemplary embodiments, the IPTV gateway 145 can include a back end 146 and a front end 147. The front end 147 can be used to implement various provisioning activities such as but not limited to initial provisioning of IPTV addresses for the devices at the subscriber location 105. The back end 146 can be implemented for many of the media connect services, such as communicating with the content services provider server 160 and retrieving scheduling and programming data from the database 165, and passing messages and notifications to the IPTV gateway 145. As such, the back end 146 can include various elements including but not limited to a caller ID handler, SMS handler, message handler, and provisioning handler.

In exemplary embodiments messages and notification can be sent between the IPTV gateway 145 and the subscriber location 105. In exemplary embodiments; the message and notifications can be implemented via an email message. In exemplary embodiments, the IPTV gateway 145 is responsible for retrieving email messages that have been sent to an IPTV subscriber and providing notification of the reception of the email message to the IPTV subscriber at the subscriber location 105. A notification can be in the form of a “popup” display window displayed at a suitable device (e.g., the communications device 110) or any other conventional message notification scheme. As discussed above, the IPTV gateway 145 can present a history of the notifications to the IPTV subscriber.

In exemplary embodiments, the IPTV gateway 145 interfaces with a POP3 infrastructure in order to retrieve email messages that have been directed to an IPTV subscriber. Additionally, the IPTV gateway 145 can interface with the preferences server 150. As described herein, the preferences server 150 is responsible for handling the performance preferences for the system 100 as dictated by the desires of an IPTV subscriber. Further, the IPTV gateway 145 is responsible for retrieving an IPTV subscriber's preferences for the set top box 115.

In exemplary embodiments, the IPTV gateway 145 interacts with the IPTV infrastructure 140 to accomplish the actual transmittal of the email message to the set top box 115. Further, all email notifications that are generated within the system 100 are saved to a log at the IPTV gateway 145. In exemplary embodiments, the subscriber can view a listing of the received email message log on their display device via an application that runs on the set top box 115.

In exemplary embodiments, the front end 147 can include a message center application that is communication with a message center enterprise java bean (EJB) and an email handler that are included within the back-end 146. The IPTV infrastructure 140 is provisioned with the subscriber user account numbers and set top box 115 identifiers. In exemplary embodiments, the IPTV gateway 145 includes a telephone number-to-account number mapping component, wherein a provisioned telephone number correlates to the IPTV subscriber's primary household telephone number (e.g., to the device 117). The IPTV subscriber's telephone number is further associated with the IPTV subscriber's email address. Further, the telephone number and email address are linked with the subscriber's IPTV account number through a web-provisioning interface that is available within the IPTV gateway 145. The IPTV gateway 145 has the ability to retrieve email messages and any image or audio/video attachments to the message, wherein the messages and the attachments are displayed as notifications on the communications device 110.

In exemplary embodiments, the subscriber is provisioned a primary email account. The email account is associated with the telephone number of the IPTV subscriber's primary household telephone number (e.g., the local part of the subscriber's email address can comprise the primary household telephone number). The primary email account is configured to auto-forward all received email messages to a secondary email account that can be serviced by an email server. After being forwarded to the secondary email account, the email message can be configured to be deleted from the sending primary email account.

At predetermined time intervals, the back-end 146 periodically polls the email server to ascertain if the email server has received any new email messages. The back end 146 can include a POP3 reader thread, which is configured to periodically read a POP3 mailbox that has been configured to receive IPTV email messages. The back-end 146 can retrieve new email messages from the email server. For each retrieved email message, the back-end 146 saves the text of the email message, and if attached, the first image file attachment to an email log. The IPTV gateway 145 can transmit a notification to the subscriber location 105 that an email message has been received. The IPTV gateway 145 stores the received email message information, thus allowing the IPTV subscriber to retrieve the email message information at a later time period with the use of the message center application. As described herein, messages and notifications can be implemented for a variety of purposes related to the media connect services described herein.

In exemplary embodiments, the IPTV gateway 145 may implement authentication using a high-speed processing device (e.g., a computer system) that is capable of handling high volume activities conducted via communications devices, and other network entities (e.g., parts of the IPTV infrastructure 140, network 135, etc.) via one or more networks (e.g., the IPTV infrastructure 140). The IPTV gateway 145 receives requests from one or more devices from the subscriber location 105 to access network services, such as the media connect services. The IPTV gateway 145 may implement authentication software for restricting or controlling access to network. The IPTV gateway 145 may be in communication with a customer identity system (CIS) database, which stores subscriber credentials (e.g., subscriber names and passwords) established via the media connect services account.

In exemplary embodiments, the system 100 can further include the media connect services application 155 that can reside on the IPTV gateway 145. As mentioned above the media connect services application 155 can be a back end application such that client software residing on a media connect device at the subscriber location 105 (e.g., the subscriber computer 125) can make audio/video assets external to the LAN 180 available to the LAN 180. In exemplary embodiments, the media connect services application 155 can be implemented by the subscriber to access and set up an interface application 156 to implement the media connect services application 155. The interface application 156 can be implemented locally to search for and access audio/video assets for rendering on the communications device 110. The interface application 156 can further be implemented to access account information from the IPTV gateway 145 and the preferences server 150. In exemplary embodiments, the media connect services application 155 can include pointers to the content services provider server 160 for accessing scheduling information and for directing content to be recorded on the DVR 120. The pointers, in turn, provide access to the schedules stored in the database 165 for streaming to the subscriber's set top box 115 for rendering on the interface application 156. The interface application 156 is shown as residing on the IPTV gateway 145. It is appreciated that the interface application 156 can reside on the set top box 115. In further embodiments, the interface application 156 can reside partially on the IPTV gateway 145 and partially on the set top box 115. In exemplary embodiments, it is further understood that both the media connect services application 155 and the interface application 156 operate both locally to the subscriber location 105 and externally to the subscriber location 105, such as on the IPTV gateway 145 to coordinate transfer of the audio/video assets (i.e., from the RSS server 170 and storage medium 175) to the LAN 180. As further described below, the interface application 156 can be implemented to store audio/video asset data lists such that a subscriber can access the data via an interface displayed on a device such as the communications device 110. For example, the subscriber computer 125 can retrieve a list of assets from the RSS sever 170 via the media connect services application 155. The list can then be presented to the subscriber on the communications device 110 via the interface application 156.

In exemplary embodiments, the interface application 156 also provides access to the IPTV gateway 145, such that messages and notifications can be passed between the subscriber location 105 and the IPTV gateway 145 that include present scheduling and historic scheduling that the subscriber has been created in the past. Furthermore, if any changes in the subscriber's scheduled videos have occurred, messages can be passed to the subscriber location 105 (or remote device) to notify the subscriber that a program scheduled to be viewed has changed. The subscriber can make changes accordingly.

In exemplary embodiments, one of the subscriber location 105 devices, such as the subscriber computer 125, is a local broadcaster for all clients (e.g., the device 117) on the LAN 180 to listen for all available audio/video assets. As described above, the audio/video assets can be local to the subscriber location 105 from local clients (e.g., the device 117) or can be external to the subscriber location 105, and made available to the LAN 180 via the back end media connect services application 155 which is in communication with client software on the specified local device (e.g., the subscriber computer 125 as discussed). Thus the assets can be made available to the LAN 180 for consumption by the set top box 115 and presentation on the communications device 110. It is appreciated that the audio/video assets can be any asset that may not be available via subscription services with the content services provider server 160. For example, the assets may include unreleased movie trailers, previews, clips, and podcasts. It is further appreciated that the local device (i.e., the subscriber computer 125) may be part of a shared network external to the LAN 180. For example, the subscriber computer 125 may be part of a shared network with the RSS server 170 (e.g., over the network 135) and one or more other external computers such as a computer 190. According to exemplary embodiments, the RSS server 170 and the computer 190 each respectively has its own storage medium 175, 195 having external audio/video assets. The shared network among the subscriber computer 125, the RSS server 170 and the computer 190 can share assets independent of the system 100. However, the media connect services application 155 residing externally to the subscriber location can make the shared network assets available to the LAN 108. As mentioned above, the subscriber computer 125 as part of the LAN 180 can detect the assets from the RSS server 170 and retrieve an RSS list for presentation on the communications device 110. When the subscriber desires to retrieve an asset from the shared network among the subscriber computer 125, the RSS server 170 and the computer 190, the subscriber computer 125 can access the RSS list to retrieve a link to the originating source of the desired asset. The original source may be the RSS server 170 or one of the computers in the shared network among the subscriber computer 125, the RSS server 170 and the computer 190. Regardless of the original source, the media connect services application 155 is able to coordinate the transfer of those external assets to the LAN 180. In further exemplary embodiments, the subscriber computer 125 can retrieve a multiplicity of other assets from other sources (e.g., in communication with the network 135) for presentation on the LAN 180. It is appreciated that the assets can be made available via a number of mechanisms such as but not limited to metadata.

Therefore, a device at the subscriber location 105, which is on the LAN 180 can become a consumer of all audio/video assets from sources both on the LAN 180 and external to the LAN 180 (e.g., website assets, shared network assets). The device (e.g., the subscriber computer 125) can then make all of the assets available for consumption by the set top box 110 for rendering on the communications device.

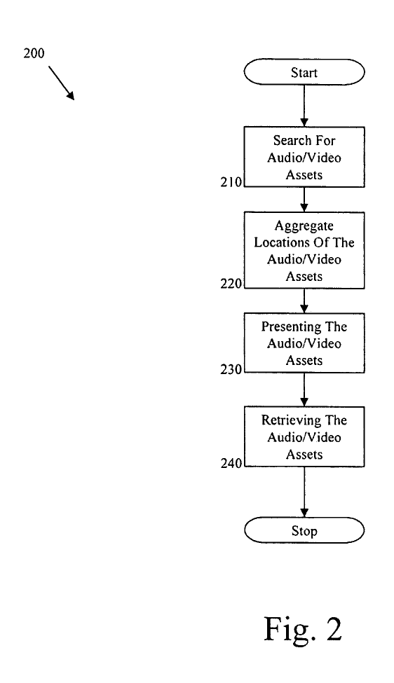

FIG. 2 illustrates a flow chart for a media connect service method 200 in accordance with exemplary embodiments. At block 210, the method 200 searches for locations of local audio/video assets available on the LAN 180, and for locations of external audio/video assets available outside of the LAN 180. In exemplary embodiments, client software residing on the subscriber computer 125 is the central device for searching for the audio/video assets, which can be via the media connect services application 155 for assets external to the LAN 180. At block 220, the method 200, via the media connect services application 155, aggregates the locations of the local audio/video assets, and the locations of the external audio/video assets on a device coupled to the LAN 180 (e.g., the computing device 125). At block 230, the method 200, via the media connect services application 155, presents the local audio/video assets on the communications device 110 coupled to the set top box 115. At block 240, in response to a request to download a subset of the local audio/video assets and the external audio/video assets, the method 200, via the media connect services application 155, retrieves the subset of the local audio/video assets and the external audio/video assets for presentation on the communications device 110.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A content management method, comprising:
searching for locations of local audio/video assets available on a local area network;
aggregating the locations of the local audio/video assets on a device on the local area network; and
presenting the local audio/video assets on a communications device coupled to the local area network.

2. The method as claimed in claim 1 wherein the device on the local area network is an Internet Protocol Television set top box.

3. The method as claimed in claim 2 wherein the communications device is an Internet Protocol-enabled television.

4. The method as claimed in claim 1 further comprising:
searching for locations of external audio/video assets available outside of the local area network;
aggregating the locations of the external audio/video assets on the device on the local area network; and
presenting the external audio/video assets on the communications device.

5. The method as claimed 4 further comprising:
aggregating the locations of the local audio/video assets and the locations of the external audio/video assets on the device on the local area network; and
presenting the local audio/video assets and the external audio/video assets on the communications device.

6. The method as claimed in claim 4 further comprising retrieving a subset of the local audio/video assets in response to a request to download the subset of the local audio/video assets to the communications device.

7. The method as claimed in claim 4 further comprising retrieving a subset of the external audio/video assets in response to a request to download the subset of the external audio/video assets to the communications device.

8. The method as claimed 4 wherein the location of the external audio/video assets is determined by a computing device coupled to the local area network.

9. The method as claimed in claim 8 wherein the external audio/video assets are downloaded via the computing device for playback on the communications device.

10. The method as claimed in claim 9 wherein the external audio/video assets are consumed by an Internet Protocol Television set top box coupled to the communications device.

11. The method as claimed in claim 1 wherein the communications device is an Internet Protocol enabled television.

12. A computer program product for content management, the computer program product including instructions for causing a computer to implement a method, the method comprising:
searching for locations of local audio/video assets available on a local area network;
aggregating the locations of the local audio/video assets on a device on the local area network; and
presenting the local audio/video assets on a communications device coupled to the local area network.

13. The computer program product as claimed in claim 12 wherein the device on the local area network is an Internet Protocol Television set top box.

14. The computer program product as claimed in claim 13 wherein the communications device is an Internet Protocol-enabled television.

15. The computer program product as claimed in claim 12 wherein the method further comprises:
searching for locations of external audio/video assets available outside of tie local area network,
aggregating the locations of the external audio/video assets on the device on the local area network; and
presenting the external audio/video assets on the communications device.

16. The computer program product as claimed 15 wherein the method further comprises:
aggregating the locations of the local audio/video assets and the locations of the external audio/video assets on the device on the local area network; and
presenting the local audio/video assets and the external audio/video assets on the communications device.

17. The computer program product as claimed in claim 15 wherein the method further comprises retrieving a subset of the local audio/video assets in response to a request to download the subset of the local audio/video assets to the communications device.

18. The computer program product as claimed in claim 15 wherein the method further comprises retrieving a subset of the external audio/video assets in response to a request to download the subset of the external audio/video assets to the communications device.

19. A content management system, comprising:
a computing device;
a set top box in communication with the computing device;
a communications device in communication with the set top box; and
a process for presenting audio/video assets on the communications device, the process having instructions for:
searching for locations of local audio/video assets available on a local area network, and for locations of external audio/video assets available outside of the local area network,
aggregating the locations of the local audio/video assets, and the locations of the external audio/video assets on a computing device coupled to the local area network,
presenting the local audio/video assets and the external audio/video assets on a communications device coupled to a set top box configured to consume the local audio/video assets and the external audio/video assets, and
in response to a request to download a subset of the local audio/video assets and the external audio/video assets, retrieving the subset of the local audio/video assets and the external audio/video assets for presentation on the communications device.

20. The system as claimed in claim 19 wherein the computing device is configured to aggregate the locations of the local audio/video assets and the external audio/video assets.
